(19) United States
(12) Patent Application Publication
(10) Pub. No.: US 2021/0310974 A1
(43) Pub. Date: Oct. 7, 2021

(54) MULTI-SENSORY DEVICE INTEGRATED IN A SINGLE STRUCTURE

(71) Applicant: KING ABDULLAH UNIVERSITY OF SCIENCE AND TECHNOLOGY, Thuwal (SA)

(72) Inventors: Muhammad Mustafa HUSSAIN, Hercules, CA (US); Sherjeel KHAN, Thuwal (SA)

(21) Appl. No.: 17/080,565

(22) Filed: Oct. 26, 2020

Related U.S. Application Data
(60) Provisional application No. 63/003,522, filed on Apr. 1, 2020.

(51) Int. Cl. G01N 27/22; G01K 7/34; G01L 1/14

(52) U.S. Cl. CPC G01N 27/226; G01N 27/225; H01G 4/002; G01L 1/144; G01K 7/34

(57) ABSTRACT

A sensor for determining plural parameters includes a housing that defines a chamber and a parallel plate capacitor having a first plate located inside the chamber and a second plate fixedly attached to a first external side of the housing. A dielectric multi-layer placed between the first and second plates includes a pressure sensitive layer and a humidity sensitive layer.

### CROSS-REFERENCE TO RELATED APPLICATION

This application claims priority to U.S. Provisional Patent Application No. 63/003,522, filed on Apr. 1, 2020, entitled “A MULTI-SENSORY SECURITY DECAL WITH THREE SENSING CAPABILITIES IN A SINGLE STRUCTURE,” the disclosure of which is incorporated herein by reference in its entirety.

### BACKGROUND

### Technical Field

Embodiments of the subject matter disclosed herein generally relate to a multi-sensory device or tag for determining plural parameters, and more particularly, to a single structure that is configured to detect three or more parameters of the ambient and/or parameters that affect the structure.

### Discussion of the Background

An asset can be defined as an object that holds a certain market value, as for example, a painting, jewelry, a laptop, etc. For the owner of the asset, the safety of the asset is important. Over time, technologies have developed so that various systems are now available for tracking and/or managing the asset's condition/location. In essence, most of the time, these systems are put in place to prevent theft or unauthorized handling of the asset. Such an asset can be hidden away in a secure vault, but often times the asset that needs protection is an object of daily use, which is exposed to an unregulated environment and/or people, for example, a laptop in a workplace, an expensive piece of decoration inside of a home, or a painting hung in an art gallery.

With an ever-increasing number of theft of high-value art assets, it has become a continuing challenge to find the right protection system for the right price. Radio-frequency identification (RFID) technology is the most popular and widely used system for inventory management, asset management, and anti-theft systems. An object tagged with an RFID tag can then be detected if it comes in proximity of an RFID reader, where the readable distance depends upon the technology and the surroundings of the tag. The maximum readable distance ranges, for most RFID systems, from a few centimeters to a couple of meters.

The limitation of this technology, however, is that it can only identify if the object is present in a close range of an RFID receiver. Furthermore, the RFID tags do not have the ability to track movement or mishandling of the object. Another serious issue with the RFID tags is that these tags can be easily removed from the object, with no way left for the RFID system to track the object once the tag is removed since the RFID technology depends on the unambiguous identification of the tagged object by the reader. There are many scenarios where a notification about an unauthorized object mishandling is desired, for example, one may want to know if anybody attempts to use the laptop or try to mishandle a precious item. The other important aspect for the protection of the assets is the capability to identify tag removal attempts to ensure that the tag stays in contact with the asset for its continuous monitoring. While the RFID technology is a vital utility for many applications, it fails to deliver when somebody tries to remove the tag.

A paper-based triboelectric nanogenerator (TENG) has been proposed as an anti-theft sensor for books. It adheres to a page of the book, where the triboelectric generator harvests energy from the movement of the pages. Consequently, when the book is moved vigorously, it can use the harvested energy to signal an alarm using an LED or a buzzer. This approach has some limitations as it is largely dependent upon the frequent use of the same page in order to harvest sufficient energy. Most assets like artworks, paintings, and laptops stay in one place and do not move enough to generate useful energy. Thus, such a sensor would fail to notify the owner of the asset about the movement of such assets. Furthermore, this type of sensor, although self-powered, lacks integration into a wireless sensor networks. An LED or small buzzer cannot stop someone from stealing the object. Lastly, for the same reason as the RFID tags, this sensor lacks any anti-tampering detection or capability, and the sensor can be easily removed from the asset to which is attached, thus leaving the asset without protection.

Wireless Sensor Networks are being proposed for anti-theft and they are made using a combination of sensors like light sensors, vibration sensors, GPS, pressure, and other sensors [1, 2]. The combination of multiple sensors to track the asset and then the bulky processors needed to analyze that data, result in large-sized tracker boxes. These trackers, while they can track large objects like laboratory equipment, cannot be attached as a tag to most everyday objects, like a laptop or a painting.

Thus, there is a need for a new multi-sensory device that is compact, easily attachable to an asset of any size, inexpensive, and also has the capability to detect a removal of the device from the asset to be protected.

### BRIEF SUMMARY OF THE INVENTION

According to an embodiment, there is a sensor for determining plural parameters, and the sensor includes a housing that defines a chamber, and a parallel plate capacitor having a first plate located inside the chamber and a second plate fixedly attached to a first external side of the housing. A dielectric multi-layer placed between the first and second plates includes a pressure sensitive layer and a humidity sensitive layer.

According to another embodiment, there is a sensor assembly for determining plural parameters, and the sensor assembly includes a housing that defines a chamber, a parallel plate capacitor having a first plate located inside the chamber, a second plate located outside the chamber, and a dielectric multi-layer that includes a pressure sensitive layer and a humidity sensitive layer, an electronic interface attached to an outside of the housing, a processor and a memory attached to the electronic interface and configured to measure the plural parameters based on a change of a capacitance of the parallel plate capacitor, a communication device configured to transmit at least one of the plural parameters to an external device in a wireless manner, and a power source attached to the electronic interface and configured to power the processor, the memory and the communication device.

According to still another embodiment, there is a method for assembling a sensor system for measuring plural parameters. The method includes placing a first electrical terminal on a first side of an opened box so that the first electrical terminal is partially located inside of a chamber defined by the opened box, placing a first plate inside the chamber, closing the open box with a lid so that the chamber is fully closed, placing a pressure sensitive layer on the lid, placing a humidity sensitive layer on the pressure sensitive layer, and placing a second plate on the humidity sensitive layer, so that the first plate and the second plate form a parallel plate capacitor. A dielectric multi-layer of the parallel plate capacitor includes the pressure sensitive layer and the humidity sensitive layer.

### BRIEF DESCRIPTION OF THE DRAWINGS

For a more complete understanding of the present invention, reference is now made to the following descriptions taken in conjunction with the accompanying drawings, in which:

FIG. 1 is an overview of a parallel plate capacitor based sensor system capable of measuring plural parameters;

FIG. 2 shows the parallel plate capacitor based sensor system attached to an asset;

FIG. 3 illustrates a transversal cross-section of the parallel plate capacitor based sensor system;

FIG. 4 illustrates a longitudinal cross-section of the parallel plate capacitor based sensor system;

FIG. 5 illustrates a shape of a fixed plate of the parallel plate capacitor based sensor system;

FIGS. 6A to 6C illustrate how the overlapping area between the moving plate and the fixed plate of the parallel plate capacitor changes as the sensor is tilted clockwise or counterclockwise;

FIG. 7 is a flow chart of a method for assembling a parallel plate capacitor based sensor system;

FIG. 8 illustrates a programmable system on chip that can be implemented in the parallel plate capacitor based sensor system for measuring plural parameters;

FIGS. 9A and 9B illustrate the parallel plate capacitor based sensor system integrated with a battery and a processor;

FIGS. 10A to 10C illustrate the response of the parallel plate capacitor when the stimuli is a pressure or temperature or drops of a liquid;

FIG. 11 shows the parallel plate capacitor based sensor system being attached to a toy for giving a perspective about the size of the system; and

FIG. 12A shows how the parallel plate capacitor based sensor system responds to various amounts of a liquid, FIG. 12B shows how the sensor system responds to various applied pressures, and FIG. 12C shows how the sensor system responds to applied heating.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a three-sensory integrated system that can be home made, with only materials available around the house. However, the embodiments to be discussed next are not limited to such a homemade device or to three sensors, but may be applied to industrially manufactured devices that use the same principles as the home made sensor and can include more than three sensors.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

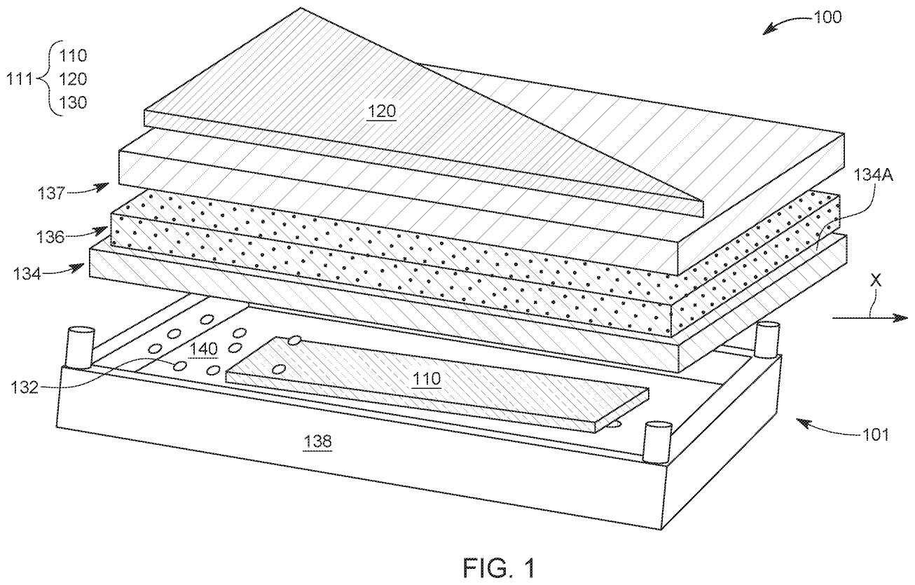

According to an embodiment, a small-sized multi-function sensor 100 is equipped with a liquid (humidity) detection capability, a heat (temperature) detection capability, and a touch (pressure) capability, all embedded in a single device/tag in the form of a single parallel plate capacitive structure, as illustrated in FIG. 1. The sensor can be made by using low-cost, lightweight paper-based (common household) recyclable materials like a sponge, wipes, and copper foil, everything housed in a 3D printed enclosure, so that altogether the entire sensor weigh less than 2 g, for example, about 1.5 grams. This sensor can be assembled using Do-it-Yourself (DIY) based techniques presenting the benefits of customization where anyone can modify the sensor shape/size according to their needs without requiring any sophisticated equipment. However, in a different embodiment, the sensor 100 can be made with more expensive materials and within a controlled industrial environment for mass producing such sensors.

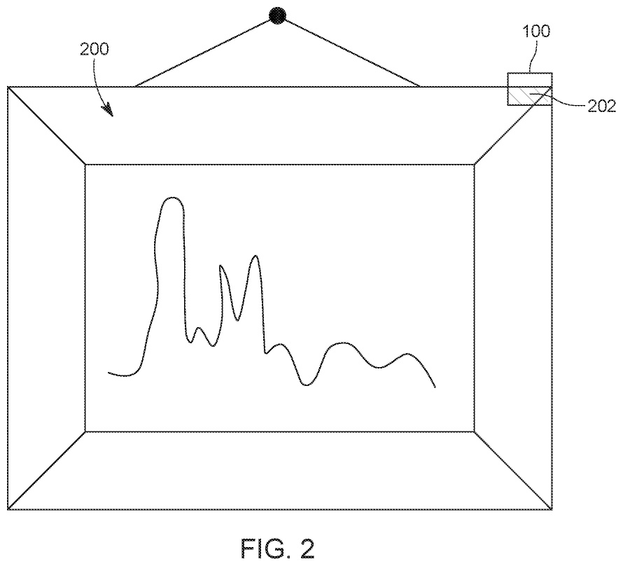

In one application, the sensor can be attached in the form of a tag to an asset 200, for example, a picture in a museum as illustrated in FIG. 2, using an adhesive 202. In order to identify tampering and/or tag removal attempts, the three sensor capabilities (liquid, heat and touch) are smartly embedded in the same parallel plate capacitive structure such that all the sensing capabilities share a single output terminal which may be directly connected to a Bluetooth Low Energy (BLE) PSOC powered by a power source, e.g., a 3V coin cell battery. The sensing materials may be low-cost and readily available with comparable performances to state-of-the-art sensors while having the novelty of containing the plural sensing functionalities integrated into a single structure. In one embodiment, a fourth sensing capability, tilt detection, is added to the single sensor structure 100. In one application, the response times for the various sensing capabilities are fast, to ensure that an immediate action can be taken in case of any alert generated.

The sensor 100 is show in FIG. 1 as having a parallel plate capacitor 111 formed partially inside a housing 101 and partially outside the housing 101. The housing is formed from a base or box 138, which is open, and a lid 134, which is configured to close the open box 138 and form a closed chamber 140, which is fully located within the housing 101. The parallel plate capacitor 111 has a first metal plate 110 formed within the closed chamber 140, and a second metal plate 120, formed outside the housing 101, on the lid 134. A dielectric multi-layer 130, located between the first and second metal plates 110 and 120 completes the structure of the capacitor 111 and includes plural layers of material.

One of these layers is a layer of air 132 formed inside the chamber 140, which is located between the first plate 110 and the lid 134. Thus, the dielectric multi-layer 130 also includes (a) the lid 134, which is made from, for example, a polymer, (b) a pressure sensitive layer 136, which is made from, for example, a sponge, and (c) a liquid sensitive layer 137, which is made from, for example, a microfiber wipe. Other materials may be used for any of these components as long as they comply with their functionalities noted above.

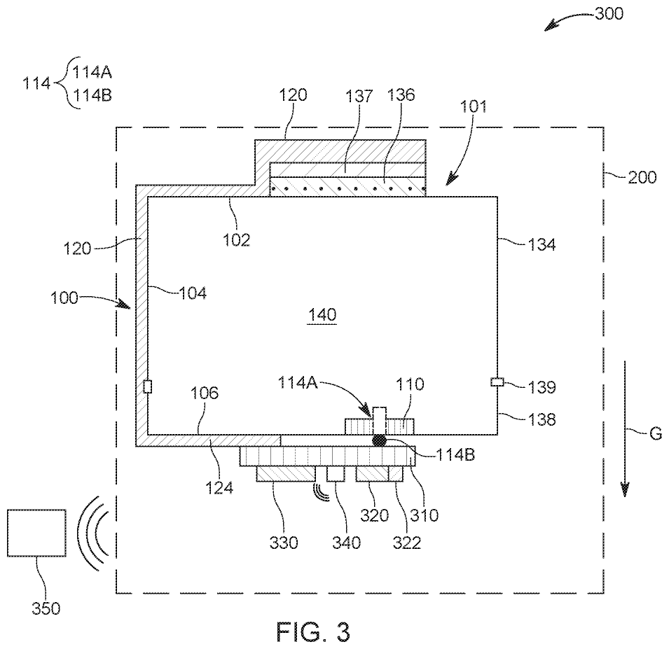

To hold in place these layers of the dielectric multi-layer 130, it is possible, in one embodiment, to make the second metal plate 120 from a flexible material, for example, copper tape, and to use additional material for the second metal plate 120 to extend it, as shown in FIG. 3, from a first side 102 of the housing, around a side face 104 of the housing 101, up to a second side 106 of the housing, which corresponds to the box 138, and is opposite to the first side 102. In this way, the extended second metal plate 120 and the lid 134 sandwich the pressure sensitive layer 136 and the liquid sensitive layer 137 so that they stay in place.

FIG. 3 shows a full sensor system 300 that includes the sensor 100 attached to the external object 200. The system 300 also includes an electronic interface or substrate 310, which is electrically connected to two electrical terminals 114 and 124, which are the two electrical contacts of the capacitor 111. The electronic interface or substrate 310 may be configured to support a processor 320 and a power source 330. The processor 320 may have a memory device 322 for storing the collected information, and, for example, an algorithm for transforming the collected capacitance into one or more of the desired parameters, which are discussed later. A communication device 340 (for example, Bluetooth enabled transceiver) may also be attached to the substrate 310 and powered by the power source 330. Such a sensor system 300 is then able not only to determine the desired parameter, but also to send the parameter to an external device, e.g., server or computer or mobile device 350, in a wireless manner, to alert the external device about a change in that parameter.

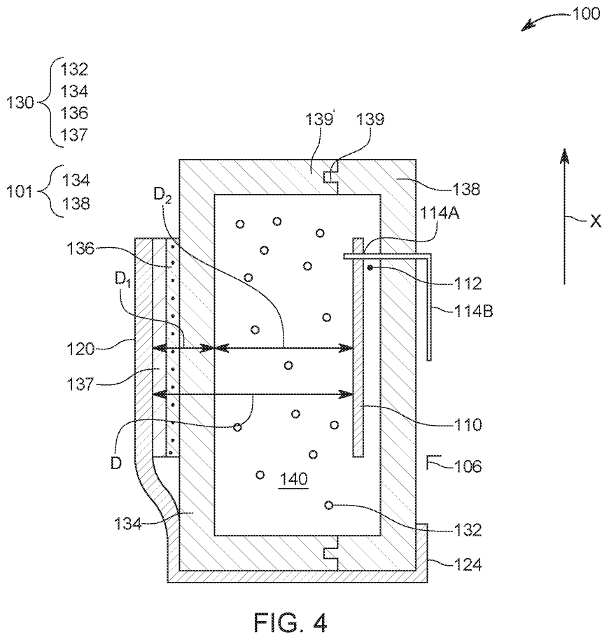

FIG. 3 shows the first electrical terminal 114 having a first portion 114A that enters inside the box 138, and a second portion 114B that extends outside the box. More specifically, as shown in FIG. 4, which illustrates a longitudinal cross-section of the sensor 100, the part 114A of the first electrical contact 114 extends inside the chamber 140 and also can enter through the first plate 110 or can only be attached to the first plate 110. In one embodiment, the first plate 110 is fixedly attached to the box 138. However, as shown in FIG. 4, the first plate 110 can be a moving plate, when hung from the part 114A of the first electrical contact 114, so that the moving plate 110 can freely oscillate about the part 114A. In other words, the moving plate 110 may move as a pendulum.

The parallel plate capacitive structure or capacitor 111 thus includes, in the embodiment of FIG. 4, the moving metal plate 110 (which also can be fixed as shown in the embodiment of FIG. 1) and the fixed metal plate 120. The lid 134 may be detachably attached to the box 138, for example, using one or more posts 139. The posts are fixedly attached either to the box or to the lid, and corresponding holes 139′ are formed in the lid or box, respectively. Then, when the lid is placed over the box, the posts enter inside the corresponding holes and ensure that the lid does not fall off the box. In one embodiment, it is possible that a glue or other similar material is placed on the posts or holes or box to ensure a good adherence between the lid and the box. The box and the lid may be made of the same material or different materials. They may be made of any materials as long as the materials are dielectric materials. The lid may be attached to the box by using different means, as known in the art.

Still with regard to FIG. 4, the moving plate 110 is attached at one location 112 to the box 138, so that it can act as a pendulum when the box is placed in a vertical position. FIG. 4 shows the moving plate 110 in a vertical position, facing the fixed plate 120 through the dielectric multi-layer 130, and extending along the X direction. The X direction coincides in this embodiment with a longitudinal axis of the moving plate 110. The fixed plate 120 is fixedly attached to the lid 134. FIG. 4 also shows the fixed plate 120 extending all the way to the second side 106 of the housing 101 so that both terminals 114 and 124 are formed on the same side of the housing. In this way, the electronics discussed above may be easily attached to the two terminals 114 and 124 of the capacitor 111. Note that the capacitor 111 has no other terminals.

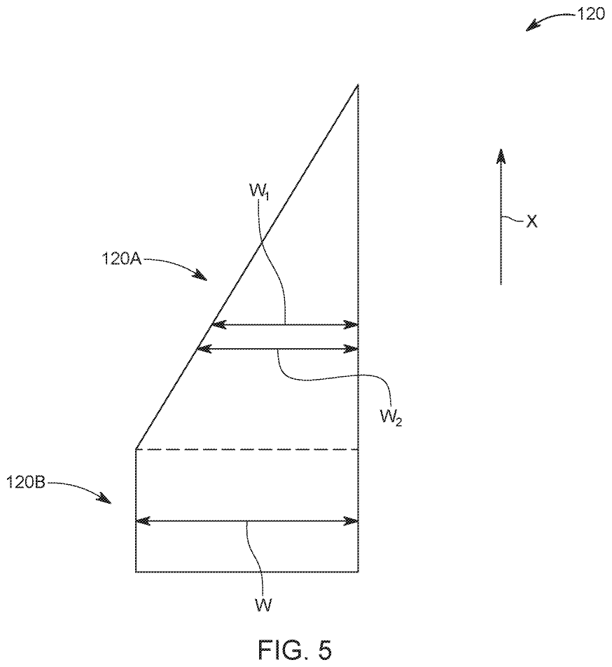

Returning to FIG. 1, the fixed plate 120 can be made to have a varying width along the longitudinal axis X of the moving plate 110, i.e., for at least a portion of the fixed plate, for each location of the at least a portion of the fixed plate 120 along the X axis, a corresponding width is different from a width of an adjacent location of the at least a portion of the fixed plate. For the embodiment illustrated in FIG. 1, the at least a portion extends over the entire fixed plate. However, as shown in FIG. 5, the fixed plate 120 may have the at least a portion 120A of the plate 120 having the width W varying from one location (W1) to an additional location (W2), while another portion 120B has a constant width W. Thus, in one embodiment, any shape can be used for the fixed plate 120 as long as there is the at least one portion 120A with the varying width W. This varying shape is required only if one of the functionalities of the sensor 100 is to determine a tilt angle, as discussed later. However, if the tilt angle is not measured by the sensor 100, then the fixed plate 120 may have a shape with a constant width W or any other shape.

Still with regard to FIG. 1, a top portion 134A of the lid 134 is not covered by the fixed plate 120. In one embodiment, the portion 134A can have an area as large as half of the top surface area of the lid 134. In one embodiment, the area of the fixed plate 120 is half or less than the area of the portion 134A. If the tilt angle is not desired to be determined by the system 100, then the area of the fixed plate 120 can be as large as the area of the lid.

As shown in FIG. 4, when the lid 134 is placed in contact with the box 138, a closed chamber 140 is formed, which ensures that a distance D between the fixed plate 120 and the moving plate 110 (fixed plate if the tilt angle is not desired to be measured) does not change. In addition, the chamber ensures that most of the ambient elements cannot enter inside the chamber to change the dielectric constant of the medium between the two plates 110 and 120. The distance D between the two plates is given by (1) D1, which is the thickness of the lid 134, the pressure sensitive layer 136, and the liquid sensitive layer 137, and (2) D2, which is the thickness of the air layer 132. Note that although the fixed plate 120 may be attached to the lid 134 with a glue or bolt or screw or other equivalent material, it is considered that this extra material does not affect the dielectric constant of the material between the two plates.

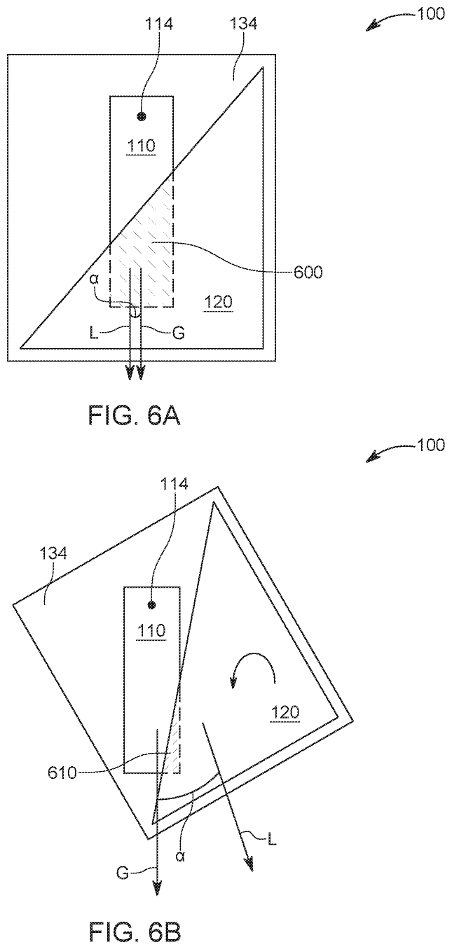

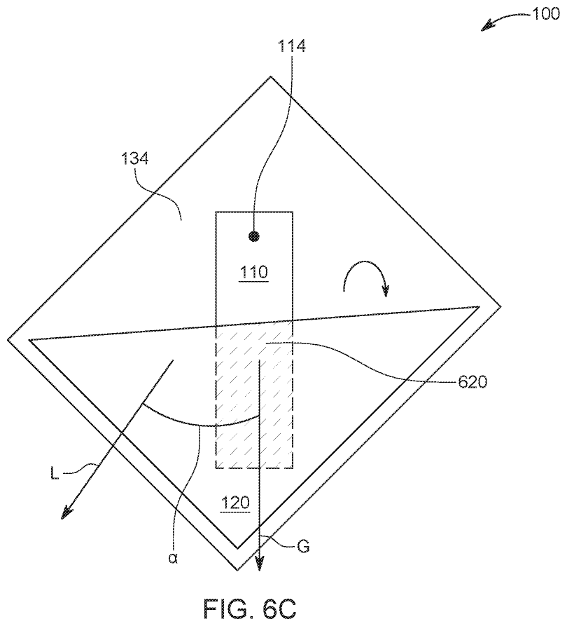

The effective capacitance of the parallel plate capacitor 111 depends upon the overlapping area of the two metal plates 110 and 120. If the sensor 100 has the fixes plate 120 shaped as illustrated in FIG. 5, the two metal plates are partially overlapped as indicated by area 600 in FIG. 6A, because of the varying shape of the fixed plate 120. Note that a longitudinal axis L of the sensor 100 is aligned in this embodiment to the gravity direction G, i.e., the angle α between the two axes is zero. The configuration of the parallel plate capacitive structure 111 acts such that when the capacitor is tilted in a counter clock-wise direction, as shown in FIG. 6B, the bottom plate 110 maintains its orientation along the gravity direction G, while all the other parts of the sensor rotate, so that the longitudinal axis L of the sensor 100 makes a non-zero angle α. Due to the change of the effective overlapping area 610 (this area decreases) of the top and bottom plates, the capacitance of the sensor 100 changes accordingly. If the sensor 100 is rotated in the opposite direction, as illustrated in FIG. 6C, an angle α is again formed between the gravity direction G and the longitudinal axis L of the sensor and the overlapping area 620 has increased. This means, that the overlapping area can be used to estimate the tilt angle α.

The two plates 110 and 120 are each connected to a corresponding electrical terminal 114, and 124, respectively, as shown in FIG. 3. FIG. 3 is a transversal cross-section of the sensor 100, and shows the housing 101 of the sensor being made of the box 138 and the lid 134. The fixed plate terminal 124 extends from the fixed plate 120, along a first side 102 of the housing 101, an entire third side 104 of the housing, and partially along the second side 106 of the housing, where the second side 106 is opposite to the first side 102. In one embodiment, the fixed plate terminal 124 and the fixed plate 120 are made of the same material, e.g., a copper tape. In one embodiment, the fixed plate terminal and the fixed plate are made as an integral piece. The fixed plate terminal 124 ends on the same second face 106 as the terminal 114, which makes easier to electrically connect the entire sensor to an electrical circuit for reading the angle between the longitudinal axis of the moving plate and the gravity, or any other parameter measured by the sensor 100.

If one of the desired parameters to be measured by the sensor 100 is the tilt angle of the housing 101 relative to the gravity, a mathematical relation is used by the processor 320 to convert the value of the capacitance of the parallel plate capacitor 111 into the angle of inclination of the housing relative to the gravity axis. Thus, it is possible to directly relate the change in the capacitance of the sensor 111 to the angle of tilt. In this regard, FIGS. 6B and 6C show that the overlapping area 600 of the two plates 110 and 120 is directly related to the tilt angle α because when the inclinometer is tilted anti-clockwise (see FIG. 6B), the overlapping area is seen to decrease and when the inclinometer is tilted clockwise (see FIG. 6C), the overlapping area increases. Thus, the sensor 100 can be used as an inclinometer, which is made to have a movable electrode acting as a pendulum inside a parallel plate capacitor. The movable plate 110 acts as the bottom plate while the top plate 120 is a fixed metal with a varying area, for example, in the shape of a triangle. When the bottom plate moves under the influence of the gravity relative to the fixed plate, the overlapping area of the two plates of the parallel plate capacitor varies, which corresponds to a change in the capacitance of the parallel plate capacitor. The relation between the angle of tilt, the overlapping area of the two plates, and the output capacitance of the capacitor is derived and used to covert the output capacitance to the tilt angle. In one application, the inclinometer has a range of 50° with a resolution of 0.38° and a response time of about 130 ms. This configuration is described in more detail in the patent application serial no. xx/xxx,xxx, titled “Parallel Plate Capacitor-based Inclinometer and Method,” and has an advantage over current methods of making the inclinometer as the existing inclinometers incorporate MEMS-based accelerometers, which need complex interface circuitry and are expensive to produce while having redundant features that are not required for many inclinometer applications. Other specialized inclinometers use fluids that are prone to environmental changes and complex to manufacture due to the presence of fluids, and all of these disadvantages are overcome by the present sensor 100.

The sensor 100 discussed in the embodiments illustrated in FIGS. 1, 3, and 4 can also be used for measuring other parameters, for example pressure, humidity and heat, independent of the tilt angle. These three capabilities were merged into the single parallel plate capacitive structure 111, thus saving space, cost, and circuit complexity. By using a single capacitive structure, only two output terminals 114 and 124 are used, which can be fed directly to the electronic interface 310 shown in FIG. 3. The parallel plate capacitive structure 111 is designed in such a way that the top plate 120 is made up of a metal whose resistance changes in response to the applied heat, which in turn leads to changes in the capacitance of the sensor 100. The bottom plate 110, which can be fixed as shown in FIG. 1 or movable as shown in FIG. 4, is also made up of a metal piece.

For the pressure and liquid sensing capabilities, the dielectric multi-layer 130 is made up of a sponge and a microfiber wipe stacked on top of each other. Those skilled in the art would understand that other materials may be used for the pressure and humidity layers 136 and 137. The thickness of the sponge changes in response to the applied pressure, resulting in a reduction of the gap between the parallel plates 110 and 120, which in turn changes the capacitance of the sensor 100. When the microfiber wipe 137 makes contact with any form of a liquid, its dielectric value changes, and thus, the capacitance of the sensor 100 changes. Thus, by calibrating these changes in the capacitance due to the various changes in the pressure, humidity, and temperature that are present around the sensor, the processor 320 of the sensor system 300 can measure these parameters. These three capabilities are now discussed in turn.

To detect any tampering attempts by a person with the sensor 100, i.e., removal of the sensor 100 from the asset 200, the pressure sensitive layer 136 is added as part of the dielectric multi-layer 130. In the embodiment illustrated in FIG. 1, the pressure sensitive layer 136 is implemented in the form of a sponge, placed in between the plates of the parallel plate capacitor 111. The sponge now acts as part of the dielectric material 130 in the parallel plate capacitive structure whose capacitance ‘C,’ which is governed by the equation (1),

$$C = ɛ \frac{A}{D} , \qquad ( 1 )$$

where ‘E’ is the permittivity of the sponge, combined with the permittivity of the lid, the humidity sensitive layer 137, and the air layer 132. As a person applies pressure on the top metal plate 120 of the sensor 100, the sponge compresses and the distance ‘D’ between the parallel plates 110 and 120 decreases, resulting in an increase in the capacitance C of the capacitor 111.

This response can be correlated to any touch or tampering event with the sensor 100 using a prior calibration, so that if anyone tries to remove the sensor 100 from the asset 200, the change in pressure can be detected and a notification can immediately be sent out to the external device 350 alerting it that this tampering event is taking place. In one application, the external device 350 is located in the control room of a security company, which based on the received warning from the sensor 100, can dispatch personnel for checking the integrity of the asset 200.

The humidity functionality of the sensor 100 is useful because the sensor is an add-on device, i.e., it needs to be bonded to any asset 200 using an adhesive. There are various kinds of adhesives with different bonding strengths. The type of adhesive will vary depending upon the asset in question. If the sensor 100 needs to be attached to human skin, skin-friendly adhesives may be used while in case of actual objects, heat curable adhesives can be used. The advantage of using adhesives is that the add-on sensor 100 can be easily attached to any object without affecting its form factor and can be removed from the object with little effort when desired.

One of the ways of removing adhesives is using organic solvents or volatile fluids. Thus, a person may use a volatile fluid on the sensor in an effort to remove the sensor from the asset, which endangers the safety of the asset monitored by the sensor 100. Generally, fluids are easily detected by using potentiometric sensors. In these sensors, a voltage is applied across electrodes and if there is a liquid in between them, a current passes through the liquid. The amount of passing current depends upon the salinity of the liquid. However, such techniques are unable to detect organic solvents which do not have ions to pass current through the solvent. Thus, as illustrated in the embodiment of FIGS. 1, 3, and 4, a microfiber wipe 137 is used, which is known to absorb fluids. To take advantage of this property, the microfiber wipe 137 is added as a liquid sensing layer in the parallel plate capacitive structure 111. Other materials (preferable inexpensive) may also be used as long as they modify the capacitance C of the capacitor 111 in such a way that the processor 320 is capable of detecting the change in the capacitance due to the presence of the fluid. The capacitance of the parallel plate capacitor 111 given in equation (1), shows that the overall capacitance depends upon the permittivity ‘ε’ of the dielectric. Wipes are porous, thus having a structure which allows for absorption and desorption of liquids from its surface. This absorption of the liquid increases the effective dielectric constant of the wipe, as water has a much higher dielectric constant than a fibrous wipe. This phenomenon is used in the capacitor 111 to detect if there is an attempt to remove the sensor 100 using solvents, by observing the corresponding increase in the capacitance due to an increase in the effective dielectric constant ‘ε’.

A third capability of the sensor 100 is now discussed. There is another possible way of removing the sensor 100 from its asset 200, for example, by using heat. Some adhesives are sensitive to temperature. Heat, on one hand, can be used to cure some adhesives while heat can also be used to debond certain kinds of adhesives. Thus, the temperature plays a critical role in the bonding strength of any adhesive. Because an adhesive will be required to attach the sensor 100 to any asset 200, there arises a vulnerability that someone can attempt to remove the sensor without touching it, for example, by using a heat source. For this purpose, a heat capability is also incorporated in the sensor 100, albeit in the same parallel plate structure 111, by using a heat sensitive metal for the top plate 120, which is outside the housing 101. The top metal plate 120 is continuously exposed to the surrounding temperature and thus, any change in the ambient temperature, which is not correlated to the change in the weather, could be associated with an attempt to remove the sensor from the asset 200. Copper, like most conductors, has a temperature dependent resistance governed by the equation (2):

R=R_{ref}(1+ζ(T−T_{ref})), (2)

where ‘R’ is the resistance at a given temperature ‘T’ and T_{ref} is a reference temperature at which the resistance R_{ref} of that material is known. ‘ζ’ is the temperature coefficient of resistance, which for copper is 0.004041. Thus, it means that with changes in the temperature, the resistance R of the copper will change. The metal plate used as the top plate 120 of the capacitor 111 acts like a resistor in series with the capacitor forming an RC circuit. The capacitance ‘C’ of a capacitor can be measured by applying a fixed amount of voltage ‘V’ across the capacitor and then measuring the time ‘t’ taken for the capacitor to fully charge to a charge level ‘Q’ as governed by equation (3):

$$Q = C V ( 1 - {e}^{( \frac{- t}{R c} )} ) . \qquad ( 3 )$$

By the application of heat, the resistance R (also called Equivalent Series Resistance) of the copper plate will rise as a result of which the time constant RC increases. Thus, it takes longer for the capacitor to charge or discharge. Due to the increased time is taken to charge the capacitor, the capacitance appears to be increased for the capacitance measured by the digital converter circuitry of the processor 320. Thus, increasing the electrode resistance causes an increase in the calculated capacitance of the parallel plate capacitive structure 111. This phenomenon is used herein to detect when heat is applied to the top metal plate 120 of the sensor 100. Some capacitors are designed such that they are not affected by temperature by using non-metallic electrodes. However, the capacitor 111 has metal plates to sense the heat applied to the sensor.

It is noted that the three capabilities of the sensor 100 discussed above, i.e., pressure, humidity and heat detection, may be implemented in the capacitor 111 independent of the tilt angle capability discussed above with regard to FIGS. 6A to 6C, or together. If the tilt angle capability is desired to be added to the other three capabilities of the sensor 100, the metal plate 110 located inside the housing 101 needs to be made to freely oscillate about a point/axis, as illustrated in FIG. 4. If this fourth capability is not desired, then the metal plate 110 may be a fixed plate.

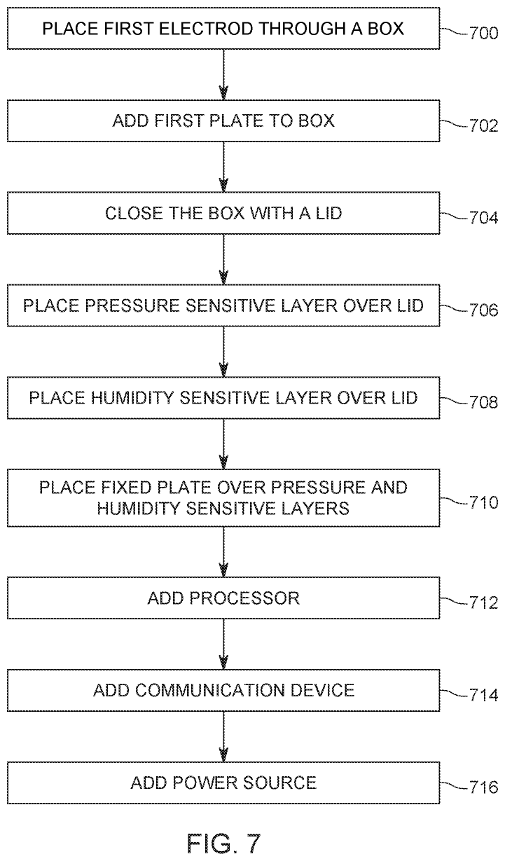

A method for assembling a sensor 100 as discussed above is now discussed with regard to FIG. 7. The assembly process starts in step 700 with a customized 3D printed housing 101 (note that other processes may be used for manufacturing the open box 138 and the lid 134) having a hole in the middle of the bottom of the box 138 through which a (rigid) metal wire 114 is passed through. This first electrical terminal acts an electrical terminal. The electrical terminal can also serve as a frictionless pivot point for supporting the moving plate 110 to be able to oscillate as a pendulum such that the moving plate can swing under the force of acceleration (movement) or gravity (tilt). This step can be modified to make the moving plate 110 to be fixed relative to the box 138, if the tilt angle is not desired to be determined. Then, the plate 110 is added in step 702 to the first electrical terminal 114. Subsequently, the lid 134 is placed in step 704 over the open box 138 to close the box and form the housing 101, which secures the plate 110. In one embodiment, the height of the housing 101 is about 2 mm and the thickness of the plate 110 is 1 mm, so that the plate 110, if selected to be a moving plate, can move freely in the chamber 140 defined inside the housing 101.

In step 706, the pressure sensitive layer 136 is placed over the lid 134, and in step 708, the humidity sensitive layer 137 is placed over the pressure sensitive layer 136. Note that the order of these two steps may be reversed, so that the humidity sensitive layer 137 is formed directly over the lid, and the pressure sensitive layer 136 is formed over the humidity sensitive layer 137. As the pressure sensitive layer 136 has a porous structure, if a liquid is poured directly over the pressure sensitive layer 136, the porous structure would absorb part of the liquid, and release some of it to the humidity sensitive layer 137, so that the reverse order of these layers does not negatively impacts the sensing of the liquid.

In step 710, the fixed plate 120 is attached to the lid. In one application, the fixed plate 120 is a copper tape shaped partially like a triangle. The fixed plate is attached to the top of the lid. Other shapes may be used as previously discussed. The fixed plate can be wrapped in this embodiment around the housing 101, towards the back side of the box so that it also acts as a second electrical terminal 124 and both terminals 114 and 124 are on the same side of the housing for easier integration with the electronic interface 310. The shape of the fixed plate is made in the shape of a triangle such that it has variable area across the width of the sensory platform, if the tilt angle is desired to be measured. If the tilt angle is not desired to be measured, the fixed plate 120 may have a constant width.

Then, in step 712, a processor and a memory may be attached to the lid or the box. The processor and the memory serve to receive a signal from the parallel plate capacitor 111, to determine a change in its capacitance when the capacitor is tilted or rotated about the first electrical terminal 114, or when a pressure is applied to the sensor, or when a liquid is poured over the sensor, or when heat is applied to the fixed plate 120, or a combination of these of actions. The processor is further configured to map the calculated capacitance to a corresponding tilt angle, or pressure, or humidity, or temperature or any combination of these parameters, as the sensor has been previously calibrated to establish the correspondence between the capacitance and these variations in the capacitance of the capacitor. A communication device 340 is attached to the housing 101 in step 714 for communicating the calculated parameter when a value of such parameter is larger than a given threshold. For powering all these electronic components, a power source 330 is added to the housing 101 in step 716.

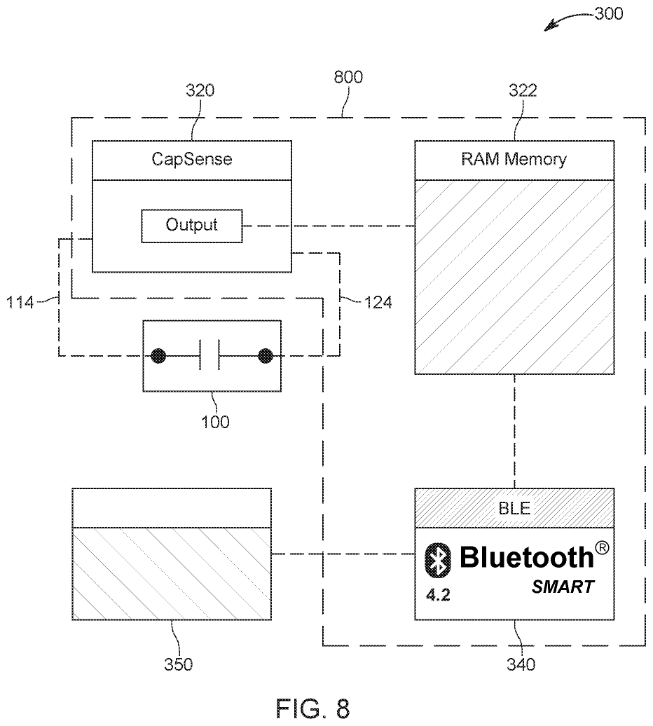

In one embodiment, the electronic components discussed in the last three steps of the method illustrated in FIG. 7 may be selected to be small and inexpensive. As discussed previously, using a discrete sensor for each stimuli detection will require complex interface circuitry, which increases the cost of the overall system and consumes a significant amount of power due to the several active components. By using a passive capacitive sensor 100, connecting the sensor to an active source of power is avoided. To keep the power consumption and cost low, the sensor system 300 uses only one chip 320, for both signal conditioning and data transmission. In one embodiment, it is possible to utilize several features available in the state-of-the-art chipset from Cypress. The internal CapSense® module 320 of the Cypress© PSoC (programable system on chip) 800 as shown in FIG. 8 can be programmed to form a capacitive analog to digital converter. This allows the sensor 100 to have a minimum possible electronic interface and all data acquisition, data conversion, signal conditioning, data processing, and data transmission is performed by a single chip.

This PSoC chip is advantageous because its 32-bit processor is integrated with a Bluetooth Low-Energy (BLE) 4.1 technology based communication module 340, to achieve wireless communication with a smartphone 350, so that the entire system 300 has a total package size of 10×10×1.8 mm. The BLE 4.1 module 340 has a special 1.3 μA low-power mode which is configured to consume significantly less power than Bluetooth 2.0 and other communication protocols like Wi-Fi and ZigBee. This module consumes just 10 mA instantaneous power while transmitting data at the maximum lowest connection interval of 7.5 ms. By increasing the connection interval to mere 100 ms, the power consumption drops down to 0.5 mA. It operates in the 2.4 GHz ISM band with an adjustable receiver frequency of +3 to −18 dBm and a 50-meter range. By having such a large range, a single receiver node 350 in a 50-meter radius space can be used to connect to all the sensors 100. Furthermore, the chip 320 comes with 256 kB flash memory and 32 kB of RAM 322, so large amounts of data can be stored on-chip before sending a bulk transmission to the receiving device 350 after every few seconds in order to save power. Furthermore, by enabling the Over-the-Air (OTA) boot-loading functionality, the system 300 can be reprogrammed wirelessly.

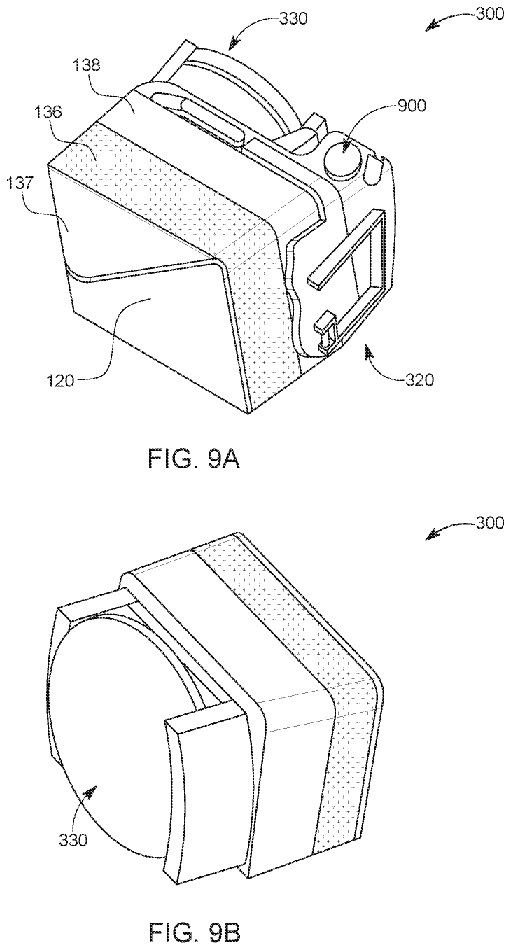

The system 300 can be powered in one application by a 3V coin cell battery (225 mAh) which can give a lifetime of 25 days based on 1-second logging intervals. In cases where the logging interval does not have to be so small, the battery life can be increased significantly while providing continuous monitoring of precious assets. The PSOC 800 is protected by an encapsulating material 900 using, for example, a glue gun, with only the antenna protruding out to prevent any damage to the electrical circuit itself as illustrated in FIGS. 9A and 9B. The net weight of the system 300 with the PSOC 800 and the coin cell battery 330 increases to 6.42 grams (3.57 grams without battery).

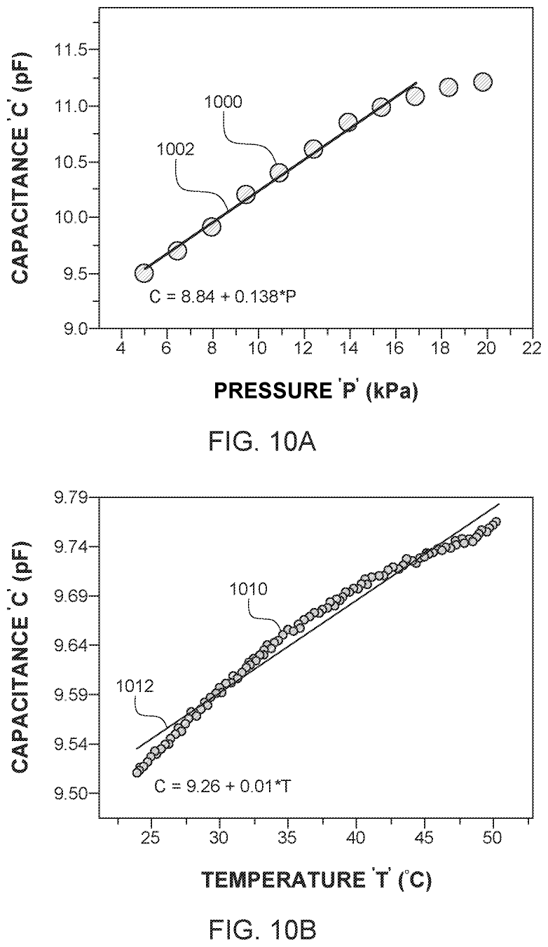

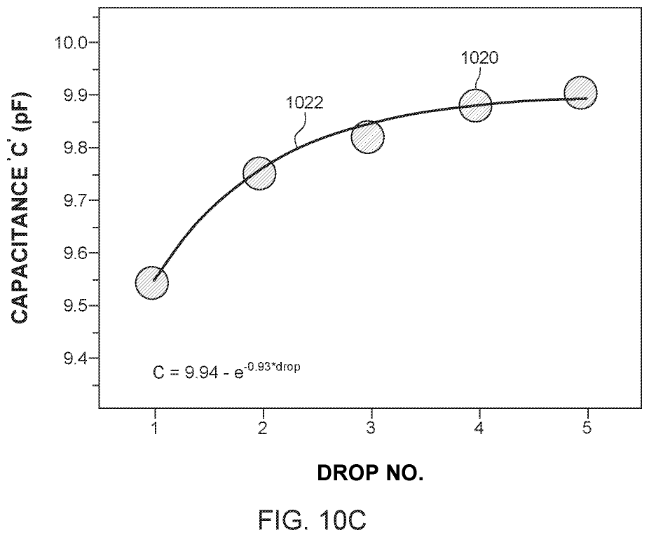

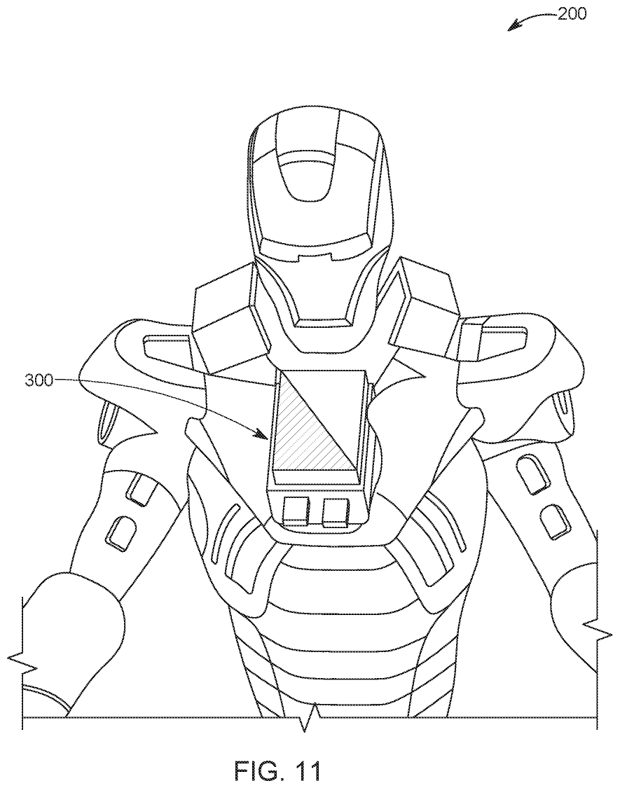

The performance of the sensor system 300 is now discussed. The individual performance of each sensor's capability was evaluated. The pressure sensing part gave a large range of operation from 0-22 kPa, which allows detection of hard presses to soft finger touches with a fast 320 ms response time, as illustrated in FIG. 10A. This figure plots a curve 1000 for the measured capacitance C versus the applied pressure P and its linear fit 1002. The fast response times and large ranges can be attributed to the sponge layer 136, which immediately compresses to the slightest touch while also being able to fully compress. Towards the end, the compressibility decreases, resulting in a linear range only until a value of 16 kPa.

The heat sensor capability shows in FIG. 10B a linear response of the capacitance when plotted against the applied temperature (see curve 1010), with a 2.1 second rise time to reach 50° C. from room temperature, when heated using a hot-air-gun. A linear plot 1012 of the capacitance versus temperature is also indicated in the figure. The humidity capability of the sensor was tested by adding drops of liquid onto the sensor 100 and analyzing the change in the output capacitance. The drops are absorbed immediately by the microfiber wipe 137 to give a fast 860 ms rise time. The absorbed water increases the dielectric of the wipe as a result of which the output capacitance increases. The measured capacitance is shown by curve 1020 in FIG. 10C and an exponential fit is shown by curve 1022. As more drops are poured in, the response saturates as the complete layer of the wipe starts to get wet.

From these experiments, it can be seen that all of the sensor's capabilities have a good linear range and performance with fast response times deeming it as a suitable anti-theft tag. Furthermore, the three in one sensor 100 or four in one sensor 100, if the plate 110 is allowed to freely move, results in the formation of a minimalist electronic interface which allows the sensor system 300 to result in a fully functional lightweight tag that can be easily attached to any asset that needs to be monitored.

As an example, the sensor system 300 was attached to a decoration object (a toy) using just a double-sided tape, as illustrated in FIG. 11. It is noted that the toy (asset) 200 has a height of about 10 cm. Because there is a single output from the sensor 100 for all three sensor capabilities, in the form of the capacitor electrodes 114 and 124, it was possible to monitor the response of the sensor 100 to various stimuli using just two wires. This provides the system 300 with an extra advantage that one sensing device (parallel plate capacitor) can be used to monitor three or four different stimuli (touch, heat, humidity, and tilt angle), resulting in a significant reduction in the sensor signal conditioning interface and power consumption. By using thresholding techniques, it is possible to detect an anomaly associated with the asset 200 to which the sensor system 300 is attached, which can be in the form of: touching the sensor, heating the sensor, pouring a solvent on the sensor in an attempt to remove the sensor from the asset, or changing a tilt angle of the asset.

However, because all stimuli responses are received at a shared output node, simple thresholding techniques cannot be used to differentiate between each kind of response and thus signal processing algorithms will be required if it is desirable to identify each stimulus separately. This is a common phenomenon in the field signal processing where, for example, a microphone can be used to differentiate between unlimited number of words/sounds based on the unique pattern each word/sound makes in the microphone's analog output. However, in one embodiment it is not important to distinguish between the various stimuli applied to the sensor system 300, but only to determine if any of the three or four stimuli changes with a value larger than a given threshold.

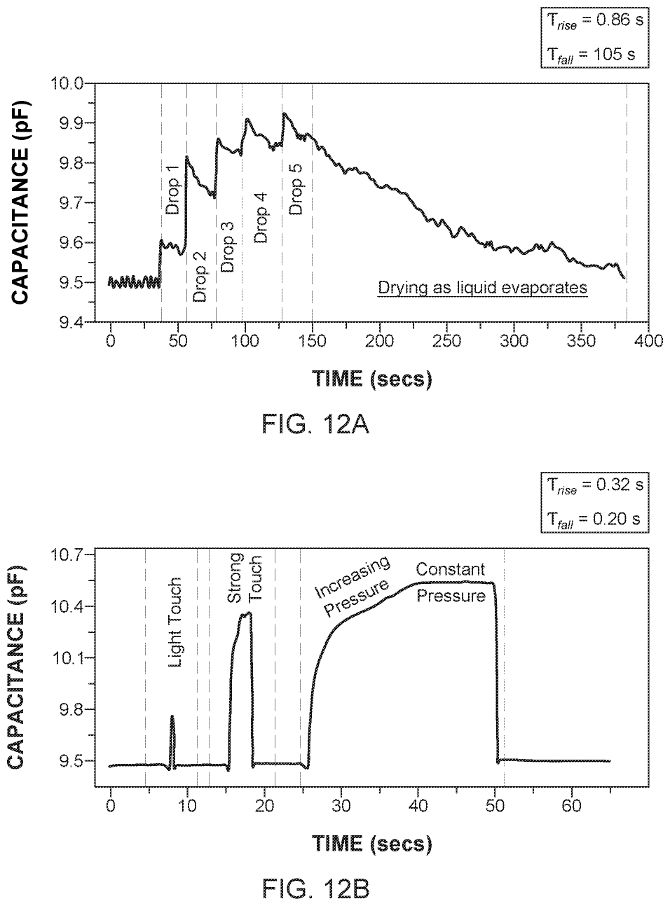

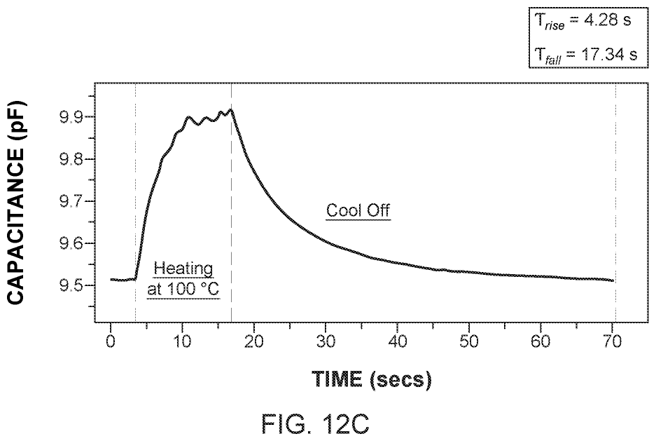

The purpose of the sensor system 300 is to obtain a device that can detect not only touch, but other actions too, that fall in the category of attempts to tamper with the sensor or remove it from the asset itself. In order to detect tamper attempts, the sensor system has the touch sensing capability. Furthermore, if someone tries to remove the sensor by using heat or solvents to dissolve the adhesive that hold the sensor to the asset, the sensor system includes heat and liquid sensing functions for detecting such actions. In this respect, FIG. 12A shows how the capacitance of the capacitor 111 rises in steps as drops of liquid are added to the moisture sensitive (microfiber wipe) layer 137. After 5 drops, the sensor 100 is left to dry and the output can be seen to linearly reach the equilibrium position albeit over an extended interval of time as the wipe desorbs the liquids slowly.

FIG. 12B illustrates the ability of the sensor to distinguish between a light, strong, increasing, and constant pressure (touch) application, as the corresponding capacitance of the capacitor 111 increases accordingly. FIG. 12C exhibits the response of the sensor 100 when heat is applied using an air blower set to 100° C. The measured capacitance of the sensor 100 rises quickly at the beginning, after which a steady point is reached. The output of the sensor steadily returns back to the starting value as the heat source is removed.

The embodiments discussed herein demonstrate the fabrication and working principles of a multi-sensory sensory tag that can be attached, like an add-on, to existing objects to be monitored, prevent theft and unauthorized usage. The tag can be made employing DIY or industrial methods using paper-based (or common household) materials to keep the cost of the tag low while allowing for a customizable design at a reduced additional cost in comparison to its semiconductor sensor counterparts. Additionally, with a novel design of integrating three or four sensing capabilities into one structure, the sensor system exhibits a multi-stimuli response by using a single parallel plate capacitive structure. If one of the plates of the capacitor is allowed to freely rotate about an axis, the sensor system is also capable of detecting a tilt angle. This structure of the sensor results in a several folds reduction in power consumption and sensor electronic interface complexity. The tag is further integrated with a single BLE chip for achieving wireless communication.

The disclosed embodiments provide a sensor system having three or more sensing capabilities that are achieved with a single parallel plate capacitor, which is inexpensive to manufacture and uses low power. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Su, C. J. In Effective mobile assets management system using RFID and ERP technology, Communications and Mobile Computing, 2009. CMC'09. WRI International Conference on, IEEE: 2009; pp 147-151.
[2] Nairne, S., Art theft and the case of the stolen Turners. Reaktion Books: 2011.

What is claimed is:

1. A sensor for determining plural parameters, the sensor comprising:
a housing that defines a chamber; and
a parallel plate capacitor having a first plate located inside the chamber and a second plate fixedly attached to a first external side of the housing,
wherein a dielectric multi-layer placed between the first and second plates includes a pressure sensitive layer and a humidity sensitive layer.

2. The sensor of claim 1, wherein the dielectric multi-layer further includes an air layer formed between the first plate and the first external side of the housing.

3. The sensor of claim 1, wherein the pressure sensitive layer is formed directly on the first external side of the housing, the humidity sensitive layer is formed directly on the pressure sensitive layer, and the second plate is formed directly on the humidity sensitive layer.

4. The sensor of claim 1, wherein the second plate is made of a metal, the pressure sensitive layer includes a porous material, and the humidity sensitive layer includes a fiber material.

5. The sensor of claim 1, wherein the first plate is free to rotate, inside the housing, relative to an axis.

6. The sensor of claim 1, wherein an overlapping area of the first plate and the second plate changes as the housing is tilted.

7. The sensor of claim 1, wherein a shape of the second plate is triangular.

8. The sensor of claim 1, wherein the housing is made of a dielectric material, the pressure sensitive layer includes a sponge, and the humidity sensitive layer includes a microfiber wipe.

9. The sensor of claim 1, further comprising:
a first electrical terminal that partially enters into the chamber and extends through the first plate,
wherein a part of the first electrical terminal extends along a second external side of the housing, wherein the second external side is opposite to the first external side, and
wherein the second plate extends from the first external side to the second external side, to form a second electrical terminal.

10. The sensor of claim 1, further comprising:
an electronic interface attached to an outside of the housing;
a power source attached to the electronic interface;
a processor and a memory attached to the electronic interface and configured to measure a change in a capacitance of the parallel plate capacitor; and
a communication device that is configured to transmit the change in capacitance to an external device.

11. The sensor of claim 1, wherein a change in a capacitance of the parallel plate capacitor is indicative of a change in heat applied to the second plate, a change in humidity of the humidity sensitive layer, and a change in pressure applied to the pressure sensitive layer.

12. The sensor of claim 11, wherein the change in the capacitance of the parallel plate capacitor is also indicative of a tilt angle as the first plate is free to rotate about an axis.

13. A sensor system for determining plural parameters, the sensor system comprising:
a housing that defines a chamber;
a parallel plate capacitor having a first plate located inside the chamber, a second plate located outside the chamber, and a dielectric multi-layer that includes a pressure sensitive layer and a humidity sensitive layer;
an electronic interface attached to an outside of the housing;
a processor and a memory attached to the electronic interface and configured to measure the plural parameters based on a change of a capacitance of the parallel plate capacitor;
a communication device configured to transmit at least one of the plural parameters to an external device in a wireless manner; and
a power source attached to the electronic interface and configured to power the processor, the memory and the communication device.

14. The sensor system of claim 13, wherein the dielectric multi-layer further includes an air layer formed between the first plate and a first external side of the housing.

15. The sensor system of claim 13, wherein the pressure sensitive layer is formed directly on the first external side of the housing, the humidity sensitive layer is formed directly on the pressure sensitive layer, and the second plate is formed directly on the humidity sensitive layer.

16. The sensor system of claim 13, wherein the second plate is made of a metal, the housing is made of a dielectric material, the pressure sensitive layer includes a sponge, and the humidity sensitive layer includes a microfiber wipe.

17. The sensor system of claim 13, wherein the first plate is free to rotate inside the housing relative to an axis and an overlapping area of the first plate and the second plate changes as the housing is tilted.

18. The sensor system of claim 13, further comprising:
a first electrical terminal that partially enters into the chamber and extends through the first plate,
wherein a part of the first electrical terminal extends along a first external side of the housing,
wherein the second plate extends from a second external side of the housing to the first external side, to form a second electrical terminal, and
wherein the second external side is opposite to the first external side.

19. The sensor system of claim 13, wherein a change in a capacitance of the parallel plate capacitor is indicative of a change in heat applied to the second plate, a change in humidity of the humidity sensitive layer, and a change in a pressure applied to the pressure sensitive layer.

20. A method for assembling a sensor system for measuring plural parameters, the method comprising:
placing a first electrical terminal on a first side of an opened box so that the first electrical terminal is partially located inside of a chamber defined by the opened box;
placing a first plate inside the chamber;
closing the open box with a lid so that the chamber is fully closed;
placing a pressure sensitive layer on the lid;
placing a humidity sensitive layer on the pressure sensitive layer; and
placing a second plate on the humidity sensitive layer, so that the first plate and the second plate form a parallel plate capacitor,
wherein a dielectric multi-layer of the parallel plate capacitor includes the pressure sensitive layer and the humidity sensitive layer.
